(19) United States
(12) Patent Application Publication
(10) Pub. No.: US 2025/0034394 A1
(43) Pub. Date: Jan. 30, 2025

(54) RESIN COMPOSITION AND MANUFACTURING METHOD THEREOF

(71) Applicant: NAN YA PLASTICS CORPORATION, TAIPEI (TW)

(72) Inventors: Te-Chao Liao, TAIPEI (TW); Chun-Che Tsao, TAIPEI (TW); Yueh-Shin Liu, TAIPEI (TW)

(73) Assignee: NAN YA PLASTICS CJORPORATION, TAIPEI (TW)

(21) Appl. No.: 18/464,276

(22) Filed: Sep. 11, 2023

(30) Foreign Application Priority Data
Jul. 25, 2023 (TW) 112127679

(51) Int. Cl. C08L 67/03; B29C 48/00; B29C 48/36; B29C 70/00; B29C 70/06; C08K 3/014; C08K 3/016; C08K 5/00

(52) U.S. Cl. CPC C08L 67/03; B29C 48/022; B29C 48/36; B29C 70/003; B29C 70/06; C08K 3/014; C08K 3/016; C08K 5/0066; B29K 2067/003; B29K 2309/08

(57) ABSTRACT

A resin composition, based on its total weight, including 35 wt % to 55 wt % of polyester, 0.1 wt % to 1.0 wt % of antioxidants, 7.5 wt % to 17.5 wt % of flame retardant, 25% to 32 wt % of filler reinforcement is provided, and a compatibilizer equivalent to 5 wt % to 15 wt % of the added amount of the filler reinforcement, is provided.

### CROSS-REFERENCE TO RELATED APPLICATION

This application claims the priority benefit of Taiwan application serial no. 112127679, filed on Jul. 25, 2023. The entirety of the above-mentioned patent application is hereby incorporated by reference herein and made a part of this specification.

### BACKGROUND

### Technical Field

The disclosure relates to a resin composition and a manufacturing method thereof, and in particular relates to a flame-retardant polyester resin composition and a manufacturing method thereof.

### Description of Related Art

Polyesters are widely used on the market or in everyday life. How to choose and formulate compositions so that the corresponding polyester material can be adapted for special or broad usage environments (e.g., potential high-heat environments and/or potential high-stress environments) has become the topic of research.

### SUMMARY

A resin composition and a manufacturing method thereof are provided. The resin composition can at least be flame-retardant.

The resin composition of this disclosure, based on its total weight, includes 35 wt % to 55 wt % of polyester, 0.1 wt % to 1.0 wt % of antioxidants, 7.5 wt % to 17.5 wt % of flame retardant, 25% to 32 wt % of filler reinforcement, and a compatibilizer equivalent to 5 wt % to 15 wt % of the added amount of the filler reinforcement.

The manufacturing method of the resin composition of the disclosure is at least formed by a kneading and extruding method, which includes the following operation. A twin screw kneading and extruder is provided. 35 wt % to 55 wt % of polyester, 0.1 wt % to 1.0 wt % of antioxidants, 7.5 wt % to 17.5 wt % of flame retardant, 25% to 32 wt % of filler reinforcement, and a compatibilizer equivalent to 5 wt % to 15 wt % of the added amount of the filler reinforcement are fed into the twin screw extruder for melt kneading modification to form a resin composition.

Based on the above, at least through the composition of the above-mentioned resin composition and its corresponding ratio, the resin composition can at least be flame-retardant and have good processability.

### BRIEF DESCRIPTION OF THE DRAWINGS

FIG. 1 is a partial schematic flowchart of a manufacturing method of a resin composition according to an embodiment of the disclosure.

FIG. 2 is a partial schematic diagram of a manufacturing equipment of a resin composition according to an embodiment of the disclosure.

### DETAILED DESCRIPTION OF DISCLOSED EMBODIMENTS

In the following detailed description, exemplary embodiments are disclosed illustrating specific details for a thorough understanding of various principles of the disclosure, for the purpose of explanation and not limitation. However, it will be apparent to those skilled in the art that, thanks to this disclosure, the disclosure may be practiced in other embodiments that deviate from the specific details disclosed herein. Moreover, the description of well-known devices, methods, and materials may be omitted so as not to obscure the description of the various principles of the disclosure.

Ranges can be expressed herein as from “about” one particular value to “about” another particular value, which can also be expressed directly as one particular value and/or to another particular value. When expressing the range, another embodiment includes from the one particular value and/or to the other particular value. Similarly, when values are expressed as approximations, by use of the antecedent “about,” it is understood that the particular value forms another embodiment. It is further understood that an endpoint of each range is expressly related or unrelated to another endpoint.

In this disclosure, non-limiting terms (e.g., may, can, for example, or other similar terms) refer to an optional or selective implementation, inclusion, addition, or presence.

Unless otherwise defined, all terms (including technical and scientific terms) used herein have the same meaning as commonly understood by one of ordinary skill in the art to which this disclosure belongs. It should be further understood that terms (such as those defined in commonly used dictionaries) should be construed as having meanings consistent with their meanings in the context of the related art, and are not to be construed as idealized or excessive formal meaning, unless expressly defined as such herein.

### [Polyester]

It should be noted that the term “polyester” (or “polyester material” and other similar terms) herein refers to any type of polyester, especially aromatic polyester.

In addition, the polyester herein may also be, for example, polytrimethylene terephthalate, polybutylene terephthalate, polyethylene naphthalate, or a combination thereof. In this embodiment, the polyester is preferably polyethylene terephthalate, polybutylene terephthalate, or a combination thereof. In addition, a copolymer can also be used, which specifically refers to a copolymer obtainable by using two or more dicarboxylic acids and/or two or more diol components.

Preferably, the polyester herein includes polyester derived from purified terephthalic acid (PTA) and ethylene glycol (EG) (i.e., polyethylene terephthalate (PET)).

In one embodiment, the polyester material used in the disclosure may include virgin polyester, recycled polyester, or a combination thereof (e.g., virgin PET, recycled PET (rPET), or a combination thereof).

In one embodiment, the polyester material used in the present disclosure or the polyester resin composition manufactured by the present disclosure may be in chip form, which may be referred to as polyester chips.

In one embodiment, for the polyester chips formed, manufactured, or obtained by the extruding method, taking the balance weighing method as an example, the number of polyester chips is greater than or equal to 80, using 2 grams as the unit of measurement.

### [Recycled Polyester Material]

The polyester recycling method includes, for example: various types of polyester-containing waste materials are collected. Corresponding sorting can be carried out according to the type, color, and/or used purpose of the aforementioned polyester-containing waste materials. Then, the sorted polyester-containing waste materials can be compressed and packaged; the packaged polyester-containing waste material can then be transported to a waste treatment plant. The aforementioned polyester-containing waste materials may include, for example, recycled PET bottles, recycled polyester films, recycled polyester release films, recycled polyester fabric chips, and recycled polyester fishnet chips, but the disclosure is not limited thereto.

The polyester recycling method may further include: items (e.g., bottle caps, labels, and/or adhesives) on the polyester-containing waste materials are removed. Then, the aforementioned polyester-containing waste materials are physically and mechanically pulverized. The pulverized polyester material is separated by appropriate means (such as a flotation method). Subsequently, the pulverized and separated polyester material is dried to obtain treated recycled polyester material.

In an embodiment, the recycled polyester material may also include, for example, treated recycled polyester material that is directly purchased.

In an embodiment, the recycled polyester material may also be waste recycling during processing (e.g., edge trim material or other similar redundant materials cut off during processing). Such recycled materials are often referred to as industrial recycled materials.

The recycled polyester material obtained by the above method can be further formed into suitable recycled polyester chips by subsequent methods.

### [Formation of Recycled Polyester Material]

In one embodiment, the recycled polyester material may include physically recycled polyester material or chemically recycled polyester material.

In one embodiment, the recycled polyester material may be melted so that it assumes a melt in a molten state. Then, the melt can be filtered through a filter screen to remove possible solid impurities therein. Afterwards, the physically recycled polyester material can be formed by extruding and forming the filtered melt in to chips using an extruder such as a commercially available single screw extruder (SSE), twin screw extruder (TSE), or other similar screw extruders, but not limited thereto.

In one embodiment, the recycled polyester material can be depolymerized by chemical depolymerization. Then, the product after the aforementioned chemical depolymerization reaction is subjected to esterification reaction. Then, the product after the aforementioned esterification reaction is subjected to a polymerization reaction. Afterwards, for example, the material in the tank can be extruded and/or cut into chips to form a chemically recycled polyester material by a chip forming method commonly used for general polymer chips.

In one embodiment, if the intrinsic viscosity of the recycled polyester material is to be adjusted, a method of increasing viscosity may be performed so that the recycled polyester material has a corresponding intrinsic viscosity range. The method of increasing viscosity may include a solid viscosity-increasing method or a liquid viscosity-increasing method. However, a viscosity-increasing method is more likely to be used to increase the intrinsic viscosity of physically recycled polyester materials, and cannot be used to reduce the intrinsic viscosity of physically recycled polyester materials.

### [Crystal Nucleating Agent]

The crystal nucleating agent may increase the total crystallinity, which may improve the heat resistance of polyester. The crystal nucleating agent may promote crystal growth, make the crystal size smaller, accelerate the crystallization speed, and reduce the generation of larger spherulites, which may reduce the possibility of polyester embrittlement.

In one embodiment, the crystal nucleating agent may include an organic crystal nucleating agent, an inorganic crystal nucleating agent, or a polymer blend thereof.

In one embodiment, the inorganic crystal nucleating agent may include mineral materials, metal oxides, silicon compounds, metal salts of inorganic acids, glass powder, metal powder, or a combination thereof. The aforementioned mineral materials may include, but are not limited to: talcum powder, titanium dioxide powder, silicon dioxide, calcium carbonate, graphite, talc, or kaolinite. The aforementioned metal oxides may include, but are not limited to: zinc oxide, aluminum oxide, magnesium oxide, or a combination thereof. The aforementioned silicon compounds may include, but are not limited to, silicon oxide, calcium silicate, magnesium silicate, or a combination thereof. The aforementioned metal salts of inorganic acids may include, but are not limited to: metal carbonates such as magnesium carbonate, calcium carbonate, sodium carbonate and potassium carbonate, barium sulfate, calcium sulfate, or a combination thereof.

In one embodiment, the organic crystal nucleating agent may include metal salts of inorganic acids, metal salts of aromatic phosphate esters, polyol derivatives, and sulfonimide compounds. The aforementioned metal salts of organic acids may include, but are not limited to: sodium benzoate, sodium octadecenoate, EMAA (Surlyn®, produced by DuPont), aluminum p-tert-butylbenzoate) or a combination thereof. The aforementioned metal salts of phosphate esters may include, but are not limited to: metal salts of aromatic phosphate esters. The aforementioned polyol derivatives may include, but are not limited to: dibenzylidene sorbitol.

In one embodiment, the size of the crystal nucleating agent may be at the micrometer (μm) level or at the nanometer (nm) level. That is to say, the crystal nucleating agent may include micrometer powder, nanometer powder or micronano powder.

In one embodiment, considering heat resistance, the crystal nucleating agent is preferably a composite or mixture of an organic crystal nucleating agent and an inorganic crystal nucleating agent. In one embodiment, the weight ratio of the organic crystal nucleating agent to the inorganic crystal nucleating agent may be about 2:1 to 1:1.

### [Flame Retardant]

In this context, “flame retardant” means that the referred object (e.g., film, layer, or structure) can pass the flame retardant standard of standard test method. For example, taking the UL94 plastic flammability standard (Test for Flammability of Plastic Materials for Parts in Devices and appliances) issued by Underwriters Laboratories Inc (UL) as an example, “flame retardant” is at least HB level, preferably, it can be above V0 level (e.g., V0 level, 5VB level, or 5VA level).

In an embodiment, the flame retardant may include a halogenated flame retardant or a halogen-free flame retardant. If halogenated flame retardants are used, they generally must at least meet the standards of the Restriction of Hazardous Substances Directive 2002/95/EC, RoHS.

In one embodiment, the flame retardant may include ether compounds. The aforementioned ether compounds may include, but are not limited to: ethyl perfluorobutyl ether (CAS number: 163702-05-4), ethyl nonafluoroisobutyl ether (CAS number: 163702-06-5), or a combination of the above.

In one embodiment, the flame retardant may include organophosphorus compounds.

The aforementioned organophosphorus compounds may include, but are not limited to: 2-carboxyethyl(phenyl)phosphinicacid (CAS number: 14657-64-8), [(6-oxido-6H-dibenz[c,e][1,2]oxaphosphorin-6-yl)methyl]butanedioic acid (CAS number: 63562-33-4), [(6-oxido-6H-dibenz[c,e][1,2]oxaphosphorin-6-yl)methyl]butanedioic acid bis(2-hydroxyethyl) ester (CAS number: 63562-34-5), bis(4-hydroxybutyl) 2-[(9,10-dihydro-9-oxa-10-oxide-10-phosphaphenanthren-10-yl)methyl]succinate and 1,4-Butanediol (CAS number: 73755-18-7), 10-benzylmethyl-9-oxa-10-phosphaphenanthrene-10-oxide (CAS number: 113504-81-7), 6,6′-(1-phenylethane-1,2-diyl)bis(6H-dibenzo[c,e][1,2]oxaphosphinine)6,6′-dioxide (CAS number: 1631149-46-6), or a combination thereof.

In one embodiment, the flame retardant may include organobromine compounds. The aforementioned organic bromine compounds may include, but are not limited to: dibromomethane, 1,2-dibromoethane, 1,2-dibromoethylene, 1,4-dibromobutane, 1,5-dibromopentane, 2,3-dibromo-2-propen-1-ol, brominated polystyrene, decabromodiphenyl ethane (DBDPE), brominated epoxy resin, tetrabromobisphenol A (TBBPA), or a combination thereof.

In one embodiment, under the premise of including the flame retardant, a flame retardant synergist may also be added.

In one embodiment, the flame retardant synergist may include sodium antimonate (NaSbO₃), antimony trioxide (Sb₂O₃, ATO), polytetrafluoroethylene (PTFE; commonly known as Teflon), or a combination thereof.

Flame retardants and flame retardant synergists can produce a synergistic effect, resulting in an overall flame retardant effect that exceeds the sum of the effects of individual components (e.g., only having flame retardants, or only having flame retardant synergists). For example, the use of antimony trioxide alone has almost no flame retardant effect; compared with the use of halogen flame retardants alone, the addition of antimony trioxide can improve the flame retardant effect of halogen flame retardants.

### [Antioxidants]

During the formation or use of polymers, polymer degradation or unexpected reactions may occur due to heat, high-energy radiation (e.g., exposure to ultraviolet light), mechanical stress, residual catalysts, reactions with other impurities, contact with oxidizing agents during usage, or other potential factors. The potential causes for the degradation or unexpected reactions of the aforementioned polymers may be due to the production of peroxy radicals, other possible free radicals, or peroxides in the polymers or their manufactured products, resulting from heat, high-energy radiation, mechanical stress, or other factors. These free radicals or peroxides may react with oxygen in the air or water vapor, producing more free radicals/peroxides, thereby triggering a corresponding vicious cycle reaction. The consequences of the aforementioned vicious cyclical reaction may render the polymer or its manufactured products prone to damage (e.g., the formation of cracks, rupture, or discoloration), thereby reducing or losing their original physical properties.

Therefore, the addition of antioxidants can inhibit the aforementioned vicious cycle reactions. The possible reason is that they (i.e., antioxidants) react with the aforementioned free radicals or peroxides, reducing the likelihood of the aforementioned vicious cycle reaction.

However, it is worth noting that if the amount of antioxidant added is too much (e.g., based on the total weight of the resin composition, the proportion of antioxidant is greater than or equal to 2 wt %, or greater than 1.0 wt %), it may cause excessive color deviation in the appearance of the resin composition.

In one embodiment, the antioxidant may include phenolic compounds, amine compounds, phosphite compounds, thioester compounds, or a combination thereof.

In one embodiment, antioxidants can be used in commercially available products with trade names/brand names such as Irganox 1010, Irganox 1425, Irganox 245, Anox 1315, Anox PP18, Anox 20, Lowinox 1790, Lowinox TBM-68, Naugard 445, Sandostab P-EPQ, Irgafos 168, and Naugard 412S.

### [Filler Reinforcement]

In the processed parts made of the resin composition, the filler reinforcement added to the resin composition may improve the mechanical strength, wear resistance and/or non-inflammability of the aforementioned processed parts.

In one embodiment, the filler reinforcement may be selected from glass fiber (GF), carbon fiber or kevlar fiber.

In one embodiment, the glass fibers are chopped strand glass fibers. In one embodiment, the glass fiber has a length between 3.0 to 4.0 millimeters (mm) and a diameter between 10 to 13 micrometers (μm).

In one embodiment, the filler reinforcement can be suitably surface modified to enhance the bonding force between it and the polyester.

In one embodiment, the surface of the glass fiber can be modified with a suitable surface modifying agent, so that the hydrophilicity and hydrophobicity of the glass fiber surface can be adjusted, such that the bonding force between the glass fiber and the polyester can be improved. In one embodiment, the aforementioned surface modification agent may include a siloxane coupling agent having corresponding reactive functional groups (e.g., vinyl group, amino group, epoxy group), but the disclosure is not limited thereto.

### [Compatibilizer]

On the premise that the filler reinforcement is included, a compatibilizer can improve the compatibility between the filler reinforcement and the polyester, and can improve the filling and/or reinforcing effect of the filler reinforcement.

In one embodiment, the compatibilizer includes ethylene-methyl acrylate-glycidyl methacrylate copolymer (E-MA-GMA), glycidyl methacrylate functionalized polyolefin elastomers (POE-g-GMA), glycidyl methacrylate functionalized polyethylene (PE-g-GMA), or a combination thereof.

### [Flow Aid]

If the corresponding polyester is formed by a melt kneading and extruding method, the addition of processing flow aids may reduce the external force (e.g., the mechanical torque when polyester raw materials are injected) required for polyester processing. In this way, it may be possible to reduce the likelihood of polymer molecular chain scission.

In one embodiment, the flow aid has good thermal stability, low volatility and good release and/or flow properties at high temperature. In one embodiment, the processing flow aid may even have a good nucleating effect on partially crystalline polyesters.

In one embodiment, the processing flow aid may include stearic acid, stearate, stearic ester (e.g., pentaerythritol stearate (PETS)), polyethylene wax, siloxane modified materials, fluoropolymer resins or a combination thereof, but the disclosure is not limited thereto.

### [Manufacturing Method of Flame-Retardant Polyester Resin Composition]

A manufacturing method of the flame-retardant polyester resin composition is exemplarily described as follows.

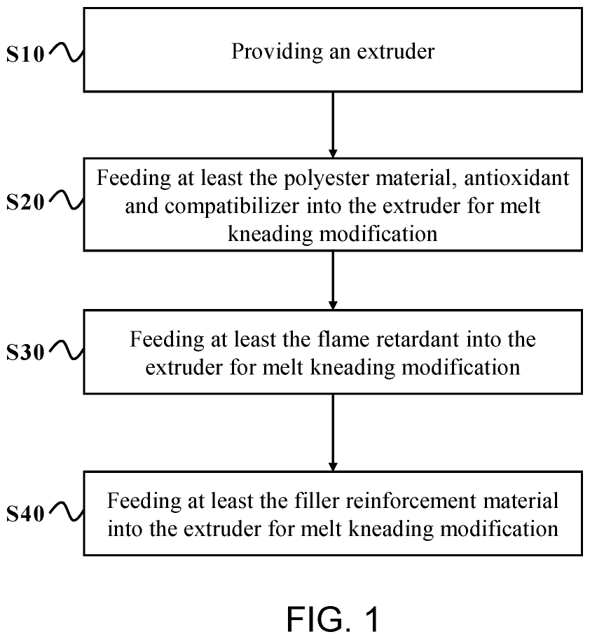

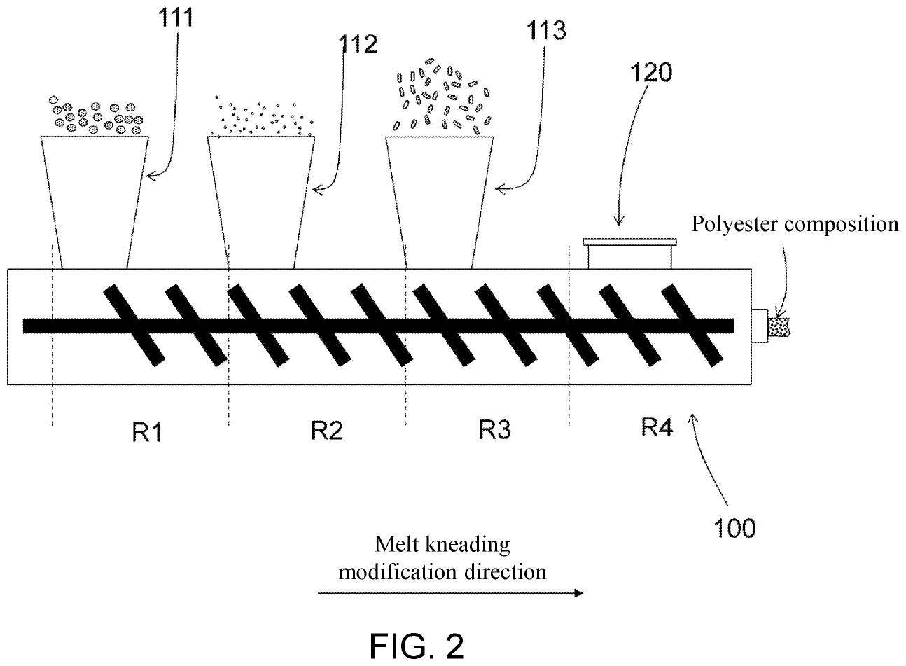

Referring to step S10 in FIG. 1 and FIG. 2, an extruder 100 is provided.

The extruder is, for example, a commercially available twin screw extruder (TSE) or other similar screw extruders, but the disclosure is not limited thereto. In addition, the disclosure does not describe in detail the structure and/or operation method of the above-mentioned commercially available screw extruder.

In one embodiment, at least one set of feeders (e.g., side feeders) may be attached to the extruder. The feeder can be a loss-in-weight feeder equipped with a loss-in-weight meter. The aforementioned feeders are also common commercially available devices and/or optional accessories. That is, the components of the aforementioned polyester mixture can be mixed before or during feeding, or they can be fed into the extruder through different feeders, and then mixed in the extruder.

Taking FIG. 2 as an example, along the extrusion direction (e.g., the direction from the polyester mixture feeding location to the location where the polyester composition is extruded or squeezed out), three sets of feeders can be attached to the extruder 100 (in order may be referred to as: the first feeder 111, the second feeder 112, and the third feeder 113). Each set of feeders can be a single feeder, or an assembly of multiple feeders.

In this embodiment, as shown in FIG. 2, the extruder 100 may have a heating zone. In this way, after the polyester mixture is fed into the extruder, the polyester mixture in the extruder can be kneaded and heated accordingly to form a corresponding polyester composition by melting and kneading, and then extruded or squeezed out.

Taking FIG. 2 as an example, along the extrusion direction (e.g., the direction from the polyester mixture feeding location to the location where the polyester composition is extruded or squeezed out), the heating zone can include the first heating zone R1, the second heating zone R2, the third heating zone R3, and the fourth heating zone R4.

In one embodiment, the heating temperature of the third heating zone R3 may be greater than or equal to the heating temperature of the second heating zone R2; and/or, the heating temperature of the second heating zone R2 may be greater than or equal to the heating temperature of the first heating zone R1.

In one embodiment, the heating temperature of the first heating zone R1 can be between about 230-250° C., the heating temperature of the second heating zone R2 can be between about 250-270° C., the heating temperature of the third heating zone R3 can be between about 255-275° C., and the heating temperature of the fourth heating zone R4 may be about 245-265° C.

In one embodiment, each heating zone is heated to a corresponding temperature (commonly referred to as preheating) before feeding.

In this embodiment, as shown in FIG. 2, the extruder 100 may be connected to an air extraction system 120. The air extraction system can include common extraction pumps and corresponding gas lines. The extruder can vent-up or improve the venting efficiency through the air extraction system.

In one embodiment, along the extrusion direction, the first heating zone R1 may correspond to the first feeder 111 and is located before the second feeder 112; the second heating zone R2 may correspond to the second feeder 112 and is located before the third feeder 113; the third heating zone R3 may correspond to the third feeder 113 and is located before the vent connected to the air extraction system 120; the fourth heating zone R4 may correspond to the vent connected to the air extraction system 120 and is located before the location where the polyester composition is extruded or squeezed out.

Referring to step S20 in FIG. 1 and FIG. 2, at least the polyester material, antioxidant and compatibilizer are fed into the extruder 100 through the first feeder 111 for corresponding melt kneading modification.

In an embodiment, the crystal nucleating agent can be further fed into the extruder 100 through the first feeder 111 for corresponding melt kneading modification.

In an embodiment, the flow aid can be further fed into the extruder 100 through the first feeder 111 for corresponding melt kneading modification.

Referring to step S30 in FIG. 1 and FIG. 2, at least the flame retardant is fed into the extruder 100 through the second feeder 112 for corresponding melt kneading modification.

In an embodiment, the flame retardant synergist can be further fed into the extruder 100 through the second feeder 112 for corresponding melt kneading modification.

Referring to step S40 in FIG. 1 and FIG. 2, at least the filler reinforcement is fed into the extruder 100 through the third feeder 113 for corresponding melt kneading modification.

By means of the above-mentioned embodiment, after the polyester-containing mixture is fed into the extruder 100, the polyester-containing mixture in the extruder 100 can be correspondingly extruded and heated to form a corresponding polyester composition through corresponding melt kneading modification by way of thermal extrusion reaction, and then extruded or squeezed out.

In one embodiment, the extruded or squeezed out polyester composition can be in the form of polyester chips by being cut into chips.

In one embodiment, based on the total weight of the mixture fed into the extruder 100, the weight ratio of the polyester material fed into the extruder 100 may be about 35 wt % to 55 wt %.

In one embodiment, the intrinsic viscosity of the polyester material fed into the extruder 100 may be about 0.55 dL/g to 0.76 dL/g, and the polyester material fed into the extruder 100 may include virgin polyester material, recycled polyester material or a mixture or combination thereof.

In one embodiment, based on the total weight of the mixture fed into the extruder 100, the weight ratio of the crystal nucleating agent may be about 1 wt % to 5 wt %; preferably, about 2 wt % to 3 wt %.

In an embodiment, the crystal nucleating agent may include a corresponding organic crystal nucleating agent and a corresponding inorganic crystal nucleating agent. In one embodiment, the weight of the organic crystal nucleating agent is about 1 to 2 times the weight of the inorganic crystal nucleating agent (e.g., the weight of the organic crystal nucleating agent: the weight of the inorganic crystal nucleating agent≈2:1 to 1:1).

In one embodiment, based on the total weight of the mixture fed into the extruder 100, the total weight ratio of the flame retardant may be about 7.5 wt % to 17.5 wt %.

In one embodiment, based on the total weight of the mixture sent into the extruder 100, the total weight ratio of the flame retardant and the flame retardant synergist may be about 10 wt % to 20 wt %; preferably, about 12 wt %.

In one embodiment, the flame retardant may include decabromodiphenyl ethane, and the corresponding flame retardant synergist may include an antimony-containing flame retardant synergist (e.g., sodium antimonate, antimony trioxide, or a combination thereof).

In one embodiment, the weight of the flame retardant is about 3 times to 7 times the weight of the flame retardant synergist (i.e., the weight of the flame retardant: the weight of the flame retardant synergist≈3:1 to 7:1); preferably, the weight of the flame retardant is about 5 times the weight of the flame retardant synergist (i.e., the weight of the flame retardant: the weight of the flame retardant synergist≈5:1).

In one embodiment, the flame retardant may include decabromodiphenyl ethane, and the corresponding flame retardant synergist may include an antimony-containing flame retardant synergist (e.g., sodium antimonate, antimony trioxide, or a combination thereof). Additionally, based on the total weight of the mixture fed into the extruder, the total weight ratio of the flame retardant and the flame retardant synergist can be about 12 wt %, in which the weight of the flame retardant is about 5 times the weight of the flame retardant synergist.

In one embodiment, based on the total weight of the mixture fed into the extruder 100, the weight ratio of the antioxidant may be about 0.1 wt % to 1.0 wt %.

In one embodiment, based on the total weight of the mixture fed into the extruder 100, the weight ratio of the filler reinforcement may be about 25 wt % to 32 wt %.

In one embodiment, based on the total weight of the mixture fed into the extruder 100, the weight ratio of the compatibilizer is equivalent to 5 wt % to 15 wt % of the added amount of the filler reinforcement.

In one embodiment, based on the total weight of the mixture fed into the extruder 100, the weight ratio of the flow aid may be about 0.05 wt % to 1 wt %.

### Example and Comparative Example

Examples and comparative examples are shown below to specifically describe the disclosure, but the disclosure is not limited by the following examples at all.

### EXAMPLE

In the manner of the above-mentioned embodiment, a polyester composition is formed. Additionally, for the foregoing embodiments, the following steps or parameters are included.

The same or similar to step S10 in FIG. 1 and FIG. 2, an extruder identical or similar to the extruder 100 is provided. The heating temperature of the heating zone that is the same as or similar to the first heating zone R1 is about 230-250° C., the heating temperature of the heating zone that is the same or similar to the second heating zone R2 is about 250-270° C., the heating temperature of the heating zone that is the same or similar to the third heating zone R3 is about 255-275° C., and the heating temperature of the heating zone that is the same or similar to the fourth heating zone R4 is about 245-265° C. Additionally, an air extraction system that is the same or similar to the air extraction system 120 is activated to vent-up the extruder.

The same or similar to step S20 in FIG. 1 and FIG. 2, the polyester material, antioxidant, compatibilizer, crystal nucleating agent, and flow aid are fed by the feeder that is the same or similar to the first feeder 111 into the extruder for corresponding melt kneading modification.

The same or similar to step S30 in FIG. 1 and FIG. 2, the flame retardant and flame retardant synergist are fed into the extruder through the feeder that is the same or similar to the second feeder 112 for corresponding melt kneading modification.

The same or similar to step S40 in FIG. 1 and FIG. 2, the filler reinforcement is fed into the extruder through the feeder that is the same or similar to the third feeder 113 for corresponding melt kneading modification.

Based on the total weight of the mixture (including polyester material, antioxidant, compatibilizer, crystal nucleating agent, flow aid, flame retardant, flame retardant synergist and filler reinforcement) fed into the extruder, the weight ratio of the antioxidant can be about 0.1 wt % to 1.0 wt %, the weight ratio of the compatibilizer can be about 5 wt % to 15 wt %, the weight ratio of the crystal nucleating agent is about 2 wt % to 3 wt %, the weight ratio of the flow aid can be about 0.05 wt % to 1 wt %, the total weight ratio of the flame retardant and the flame retardant synergist is about 12 wt %, and the weight ratio of the filler reinforcement can be about 25 wt % to 32 wt %, and the rest can be polyester material. The polyester material is polyethylene terephthalate, and its intrinsic viscosity may be about 0.55 dL/g to 0.76 dL/g. Intrinsic viscosity (IV) could be increased by a viscosity-increasing method, which may include a solid viscosity-increasing method or a liquid viscosity-increasing method.

Through the steps and parameters of the above [Example], the extruded or squeezed out polyester composition can have the characteristics shown in the following [Table 1].

### Comparative Example 1

By using the same or similar extruder to the one used in [Example], and by applying the same or similar parameters (e.g., temperature, vent conditions) for the corresponding thermal extrusion reaction, the corresponding polyester composition can be obtained.

The same or similar to step S20 in FIG. 1 and FIG. 2, the polybutylene terephthalate (PBT) is fed into the extruder by the same or similar feeder as the first feeder 111 for corresponding melt kneading modification.

The same or similar to step S40 in FIG. 1 and FIG. 2, the filler reinforcement is fed into the extruder through the feeder that is the same or similar to the third feeder 113 for corresponding melt kneading modification.

Based on the total weight of the mixture (including polybutylene terephthalate and filler reinforcement) fed into the extruder, the weight ratio of the filler reinforcement can be about 30 wt %, and the rest can be polybutylene terephthalate.

Through the steps and parameters of the above [Comparative Example 1], the extruded or squeezed out polyester composition can have the characteristics shown in the following [Table 1].

### Comparative Example 2

By using the same or similar extruder to the one used in [Example], and by applying the same or similar parameters (e.g., temperature, vent conditions) for the corresponding thermal extrusion reaction, the corresponding polyester composition can be obtained.

The same as or similar to step S20 in FIG. 1 and FIG. 2, the polyester material is fed into the extruder through a feeder that is the same or similar to the first feeder 111 for corresponding melt kneading modification.

The polyester material used for [Comparative Example 2] is substantially the same or similar to the polyester material used in [Example].

Through the steps and parameters of the above [Comparative Example 2], the extruded or squeezed out polyester composition can have the characteristics shown in the following [Table 1].

### Comparative Example 3

By using the same or similar extruder to the one used in [Example], and by applying the same or similar parameters (e.g., temperature, vent conditions) for the corresponding thermal extrusion reaction, the corresponding polyester composition can be obtained.

The same as or similar to step S20 in FIG. 1 and FIG. 2, the polyester material is fed into the extruder through a feeder that is the same or similar to the first feeder 111 for corresponding melt kneading modification.

The same or similar to step S40 in FIG. 1 and FIG. 2, the filler reinforcement is fed into the extruder through the feeder that is the same or similar to the third feeder 113 for corresponding melt kneading modification.

The polyester material used for [Comparative Example 3] is substantially the same or similar to the polyester material used in [Example].

Based on the total weight of the mixture (including polybutylene terephthalate and filler reinforcement) fed into the extruder, the weight ratio of the filler reinforcement can be about 30 wt %, and the rest can be polyester material.

Through the steps and parameters of the above [Comparative Example 3], the extruded or squeezed out polyester composition can have the characteristics shown in the following [Table 1].

### Comparative Example 4

Commercially available 30% glass fiber reinforced polyethylene terephthalate is directly used (e.g., PET engineering plastic with the brand number of 4410G6, manufactured by Nan Ya Plastics Corporation), which can have the following characteristics in [Table 1].

TABLE 1

| | Comparative | Comparative | Comparative | Comparative | |
|---|---|---|---|---|---|
| | Example 1 | Example 2 | Example 3 | Example 4 | Example |
| Composition | PBT + | Unmodified | rPET + | Commercially | An |
| | 30% GF | PET | 30% GF | available GF | embodiment |
| | | | | reinforced | |
| | | | | polyester | |
| Specific weight | 1.59 | 1.35 | 1.52 | 1.58 | 1.58 |
| (g/cm³) | | | | | |
| Izod impact | 8 | 3.5 | 8 | 7.5 | 8.2 |
| strength | | | | | |
| (kg-cm/cm) | | | | | |
| Tensile strength | 110 | 60 | 135 | 100 | 125 |
| (MPa) | | | | | |
| Elongation rate | 3.5 | 5.2 | 3.2 | 3.2 | 3.0 |
| (%) | | | | | |
| Flexural Strength | 150 | 88 | 160 | 148 | 148 |
| (MPa) | | | | | |
| Flexural Modulus | 8,000 | 2,400 | 8,500 | 9,000 | 9,800 |
| (MPa) | | | | | |
| Flame | 1.5 mm | HB | HB | 1.2 mm | 0.8 mm |
| Retardancy | V0 | | | V0 | V0 |
| Heat deflection | 206 | 70 | 212 | 210 | 221 |
| temperature (° C.) | | | | | |
| Melt index (g) | 40 | 46 | 34 | 28 | 42 |

In the example and comparative examples shown above, the evaluation methods or standards may be the same or similar to those described below.

Specific weight: tested according to ASTM D 792 test standard.

Izod Impact Strength: tested according to ASTM D 256 test standard.

Tensile strength and/or elongation rate: tested according to ASTM D 638 test standard. Sample size (mm): (165±2)×(19±0.2)×(3.2±0.2), the tensile speed is 50 mm/min.

Flexural strength and/or flexural modulus: tested according to ASTM D 790 test standard. Sample type sample size (mm): (127±2)×(12.7±0.2)×(3.2±0.2), Flexural speed is 13 mm/min.

Flame retardancy: according to the UL94 plastic flammability standard issued by the Underwriters Laboratories of the United States, the order from lowest (minimum flame retardancy) to highest (maximum flame retardancy) is: HB, V2, V1, V0, 5VB, 5VA.

Heat deflection temperature (HDT): tested according to ASTM D 648 test standard. A higher HDT value indicates that the corresponding deformation occurs at higher temperatures; a lower HDT value indicates that the corresponding deformation occurs at lower temperatures.

Melt index (MI): tested according to ASTM D 1238 test standard. The larger the MI value, the higher the fluidity; the smaller the MI value, the lower the fluidity.

The polyester composition of [Comparative Example 2] is poor in the evaluation of impact strength, tensile strength, elongation rate, flexural strength, flexural modulus, etc., and it may be difficult to perform corresponding processing. In addition, the flame retardancy of the polyester composition of [Comparative Example 2] is low.

The melt index of the polyester composition in [Comparative Example 4] is too low (<30 grams), and it is difficult to process it into a thin injection product with a thickness of less than 1 mm.

Compared with [Comparative Example 1] to [Comparative Example 4], the polyester compositions of the above example may have better flame retardancy and/or higher heat distortion temperature. Moreover, since the polyester composition of the above example has a relatively high melt index, it can be suitable for processing into thinner (e.g., less than 1 mm) injection products (e.g., connector adapters).

Compared with [Comparative Example 1] to [Comparative Example 4], the evaluation of general processability parameters such as impact strength, tensile strength, elongation rate, flexural strength, and/or flexural modulus of the polyester composition of the above example can meet the applicable specifications, or be even better. For example, the polyester composition of the above example has higher Izod impact strength, so when the polyester composition of the example or its processed product is impacted by external force, it is more difficult to break.

### INDUSTRIAL APPLICABILITY

In addition, the polyester composition (which can be chip or flake form) formed by the manufacturing method of the polyester composition of the foregoing embodiments of the disclosure can be directly or indirectly applied to the existing plastic film/injection molding process equipment or technology, and can be further processed into other products suitable for livelihood, industrial, or appropriate applications, such as but not limited to: products used in high heat and/or high external stress environments such as industrial connectors, fans, relays, etc.

What is claimed is:

1. A resin composition, wherein based on total weight of the resin composition, the resin composition comprises:
35 wt % to 55 wt % of polyester;
0.1 wt % to 1.0 wt % of antioxidant;
7.5 wt % to 17.5 wt % of flame retardant;
25% to 32 wt % of filler reinforcement; and
a compatibilizer equivalent to 5 wt % to 15 wt % of added amount of the filler reinforcement.

2. The resin composition according to claim 1, with UL94 plastic flammability standard V0 level or above.

3. The resin composition according to claim 1, wherein the polyester comprises polyethylene terephthalate with an intrinsic viscosity of 0.55 dL/g to 0.76 dL/g.

4. The resin composition according to claim 1, further comprising:
1 wt % to 5 wt % of crystal nucleating agent.

5. The resin composition according to claim 4, wherein the crystal nucleating agent comprises inorganic crystal nucleating agent and organic crystal nucleating agent.

6. The resin composition according to claim 1, further comprising:
0.05 wt % to 1 wt % of flow aid.

7. The resin composition according to claim 1, further comprising:
1.5 wt % to 5 wt % of flame retardant synergist.

8. The resin composition according to claim 7, wherein weight of the flame retardant is 3 to 7 times weight of the flame retardant synergist.

9. A manufacturing method of resin composition, at least formed by melt kneading modification, comprising:
providing an extruder; and
feeding 35 wt % to 55 wt % of polyester, 0.1 wt % to 1.0 wt % of antioxidant, 7.5 wt % to 17.5 wt % of flame retardant, 25% to 32 wt % of filler reinforcement, and a compatibilizer equivalent to 5 wt % to 15 wt % of added amount of the filler reinforcement into the extruder for a corresponding melt kneading modification to form a resin composition.

10. The manufacturing method of the resin composition according to claim 9, wherein the melt kneading modification comprises heating through the extruder.
